(19) United States
(12) Patent Application Publication
(10) Pub. No.: US 2011/0117769 A1
(43) Pub. Date: May 19, 2011

(54) INSULATION DISPLACEMENT TERMINAL, SPLICING TERMINAL ASSEMBLY AND PRESS-CONTACT STRUCTURE FOR ELECTRIC CABLE

(75) Inventors: Kenji Okamura, Yokkaichi-shi (JP); Masaaki Tabata, Yokkaichi-shi (JP)

(73) Assignee: SUMITOMO WIRING SYSTEMS, LTD., Yokkaichi-shi (JP)

(21) Appl. No.: 13/003,368

(22) PCT Filed: Jun. 25, 2009
(86) PCT No.: PCT/JP2009/061628

§ 371 Date: Jan. 10, 2011

(30) Foreign Application Priority Data
Jul. 25, 2008 (JP) 2008-192699

(51) Int. Cl. H01R 4/24

(52) U.S. Cl. 439/395

(57) ABSTRACT

A terminal fitting (10) includes a main body (20) to be coupled to a mating conductor, and a crimp contact section (30) rearward from the main body (20). The crimp contact section (30) is crimped on an end of a core wire (42) in a covered electrical cable (40) so as to surround the end. The core wire (42) includes a plurality of metallic strands (41) and is covered with a sheath (43) to form the covered electrical cable (40). Serrations (34) are provided on a contact surface of the crimp contact section (30) for surrounding the core wire (42). Each serration (34) is a polygonal shaped recess with which the core wire (42) engages upon crimping. Both diagonal corner portions (34C) of each serration (34) are rounded. Thus, the whole periphery of an opening edge around the recess penetrates an oxide layer on a core wire.

### BACKGROUND OF THE INVENTION

1. Field of the Invention

This invention relates to an insulation displacement terminal, a splicing terminal assembly, and a press-contact structure for an electric cable.

2. Description of the Related Art

Heretofore, for example an insulation displacement terminal has been utilized as a splicing terminal assembly for branching a branched line from a main line and connecting the branched line to the main line or a jointing terminal assembly for connecting a plurality of electrical cables (see, for example, JP HEI 10 (1998)-275639 A.

The insulation displacement terminal is formed by pressing a metallic plate having high electrical conductivity. The insulation displacement terminal includes a press-contact blade provided with a press-contact groove. A covered electric cable in which a conductive core wire is covered with an insulation sheath is pushed into the press-contact groove. When the covered electric cable is pushed into the press-contact groove in the press-contact blade, the insulation sheath is broken by groove edges to expose the core wire. When the exposed core wire contacts with the groove edges, they are electrically connected.

### SUMMARY OF THE INVENTION

Currently, even in a field of a wire harness for a motor vehicle, an aluminium electric cable has been used in order to reduce a weight of the covered electric cable. The aluminium electric cable includes a core wire comprising a plurality of aluminium or aluminium alloy strands and an insulation sheath covering the core wire. On the other hand, in such a kind of aluminium electric cable, if the core wire is exposed to outside air, an oxide layer is likely to be generated on a surface of the core wirer. There is a possibility that the oxide layer will be generated on the surface of the core wire at a producing stage of the covered electric cable.

Accordingly, in the case where the covered electric cable to be pushed into the insulation displacement terminal is the aluminium electric cable, when the core wire exposed by breaking, the insulation sheath contacts with groove edges of the press-contact groove, the core wire is electrically connected through the oxide layer on the core wire to the press-contact groove, so that an electrical resistance will be increased.

In the case of another electric cable (for example, a copper electric cable) except the aluminium electric cable, there is a possibility that a few oxide layer will be generated on the surface of the core wire. Consequently, there is a problem that an electrical resistance will be increased in a press-contact portion between the core wire and the insulation displacement terminal, as is the case with the aluminium electric cable.

In view of the above problems, an object of the present invention is to prevent a portion of a covered electric cable pressed onto the press-contact blade of the insulation displacement terminal from increasing an electrical resistance.

An insulation displacement terminal of the present invention comprises: a press-contact blade; and a stripping section provided on at least one of groove edges of a press-contact groove in the press-contact blade. The press-contact blade includes the press-contact groove into which a covered electric cable covered with an insulation sheath around a conductive core wire can be pushed. When the covered electric cable is pushed into the press-contact groove, the insulation sheath is broken to expose the core wire, so that the exposed core wire is brought into press-contact with the groove edges of the press-contact groove and is electrically coupled to the groove edges. The stripping section is adapted to slide on a surface of the exposed core wire.

A press-contact structure for an electric cable in accordance with the present invention is characterized in that a covered electric cable in which an insulation sheath covers an electrically conductive core wire is press-connected to the above insulation displacement terminal.

According to the above construction, since both groove edges of the press-contact groove breaks the insulation sheath when the covered electric cable is pushed into the press-contact groove in the press-contact blade, the core wire is exposed. Since the stripping section slides on the surface of the core wire, the oxide layer generated on the surface of the core wire is stripped and the emergent surface of the core wire contacts with the groove edges of the press-contact groove. Thus, an electrical resistance in the contact portion between the core wire and the press-contact blade (that is, the press-contact portion of the covered electric cable) is kept to be lower, thereby enhancing an electrical performance.

The insulation displacement terminal may include the following structures.

(1) When the insulation sheath is broken and then the stripping section slides on the surface of the exposed core wire, the stripping section strips a layer generated on the surface of the core wire, and an emergent surface on the core wire is brought into contact with the groove edges of the press-contact groove.

(2) The stripping section is provided on only longitudinal areas on the groove edges of the press-contact groove at an upstream side in a pushing direction of the covered electric cable.

In an initial pushing stage of the covered electric cable, the stripping section slides on the surface of the core wire to strip the oxide layer on the core wire. In a final pushing stage of the covered electric cable, the groove edges of the press-contact groove, on which the stripping section is not provided, slide on the surface of the core wire. Consequently, a pushing resistance in the final pushing stage is kept to be lower and a pushing force becomes small, as a whole. In the finishing stage of pushing, since the emergent surface on the core wire contacts with the areas of the groove edges on which the stripping section is not provided, it is possible to make a contact area great.

(3) The stripping section is provided on longitudinal areas on the groove edges of the press-contact groove at an upstream side in a pushing direction of the covered electric cable and on inner longitudinal areas on the groove edges of the press-contact groove at a position corresponding to a finished pushing position of the covered electric cable.

If a portion of the covered electric cable that is press-contacted with the insulation displacement terminal is located under a hard condition in which cooling and heating actions are repeated on account of a mounting position of a wire harness or the like, the core wire repeats contraction and expansion. In particular, when the core wire is contracted, a gap is caused between the core wire and the groove edges of the press-contact groove, thereby involving a possibility that another contact resistance may be generated.

On the contrary, according to the above construction, the stripping section bites the surface of the core wire at the finished stage of pushing. Consequently, a contacting condition between the stripping section and the core wire can be maintained positively even at the contraction of the core wire, thereby preventing the contact resistance from being generated.

(4) The stripping section is a stripping tooth section in which a plurality of teeth having sharply angled crest-like shape are juxtaposed in the pushing direction of the covered electric cable. Since a sharply angled distal end of each tooth that constitutes the stripping tooth section slides on the surface of the core wire in sequence, it is possible to effectively strip the oxide layer.

(5) Each tooth that constitutes the stripping tooth section is formed into a crest-like shape having a gentle slope at an upstream side in the pushing direction of the covered electric cable and a steep slope at a downstream side in the pushing direction. Since the gentle slope of the crest-like shape of each stripping tooth section contacts with the covered electric cable in sequence when the cable is pushed into the press-contact groove, the pushing resistance is kept to be lower. After finishing the pushing step, since the steep slope of each stripping tooth section engages the cable, the cable hardly comes out of the press-contact groove.

(6) The stripping section is provided with an originally cut surface to which a surface treatment of plating is not applied. The originally cut surface, to which the surface treatment of plating is not applied, is rough serrated surface. Since the rough serrated surface slide on the surface of the core wire in sequence, the oxide layer is stripped.

Furthermore, the splicing terminal assembly and the press-contact structure for an electric cable may include the following structures.

(7) A crimp terminal to be connected by crimping to an end of another covered electric cable in which an insulation sheath covers an electrically conductive core wire is connected to the above insulation displacement terminal to form the splicing terminal assembly. According to the splicing terminal assembly, in the case where a branched line is made from the main line, an intermediate position of the main line is press-contacted to the insulation displacement terminal. On the other hand, an end of the branched line can be crimped on the crimp terminal.

(8) A covered electric cable in which an insulation sheath covers an electrically conductive core wire is press-connected to the above insulation displacement terminal in the splicing terminal assembly.

(9) The covered electric cable is an aluminium electric cable in which an insulation sheath covers a core wire comprising a plurality of aluminium or aluminium alloy strands. This is particularly effective for the aluminium electric cable that is likely to generate an oxide layer on a surface of the core wire.

According to the present invention, it is possible to prevent the portion of the covered electric cable press-contacted on the press-contact blade of the insulation displacement terminal to increase an electrical resistance.

### BRIEF DESCRIPTION OF THE DRAWINGS

FIG. 1 is a perspective view of a first embodiment of a splicing terminal assembly in accordance with the present invention.

FIG. 2 is a plan view of the splicing terminal assembly shown in FIG. 1, illustrating the splicing terminal assembly on which a copper electric cable are crimped.

FIG. 3 is a plan view of the splicing terminal assembly shown in FIG. 2, illustrating the splicing terminal assembly equipped with the copper electric cable and mounted on a housing main body.

FIG. 4 is a front elevation view of a first embodiment of an insulation displacement terminal in accordance with the present invention, illustrating an aluminum electric cable under a condition before being press-contacted with the insulation displacement terminal.

FIG. 5 is a front elevation view of the insulation displacement terminal shown in FIG. 4, illustrating the aluminium electric cable under an initial press-contact condition.

FIG. 6 is a front elevation view of the insulation displacement terminal shown in FIG. 4, illustrating the aluminium electric cable under a completed press-contact condition.

FIG. 7 is a front elevation view of a part of a press-contact blade of the insulation displacement terminal in the first embodiment.

FIG. 8 is an enlarged front elevation view of a stripping tooth section of the press-contact blade shown in FIG. 7.

FIG. 9 is a front elevation view of a part of a press-contact blade of the insulation displacement terminal in a second embodiment.

FIG. 10 is a front elevation view of a part of a press-contact blade of the insulation displacement terminal in a third embodiment.

### DETAILED DESCRIPTION OF THE PREFERRED EMBODIMENTS

Referring now to the drawings, embodiments of a splicing terminal assembly in accordance with the present invention will be described below.

### First Embodiment

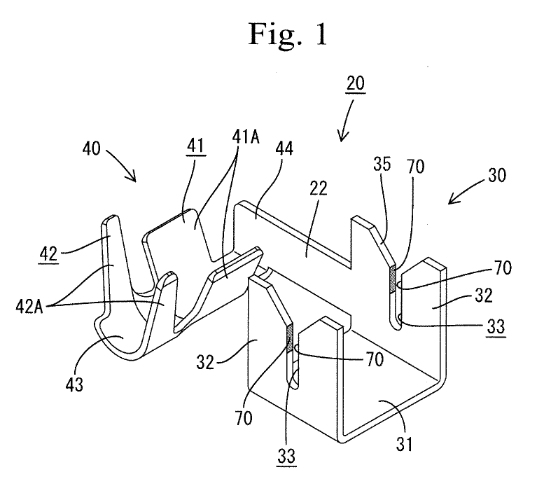

FIGS. 1 to 8 show a first embodiment of a splicing terminal assembly 20 in accordance with the present invention.

The first embodiment illustrates a case where a main line such as an electrical power sourced line is branched into and connected to a signal line for an air bag system or the like. An insulation displacement terminal 30 according to the present invention is applied to a part of the splicing terminal assembly 20 suitable for branching connection.

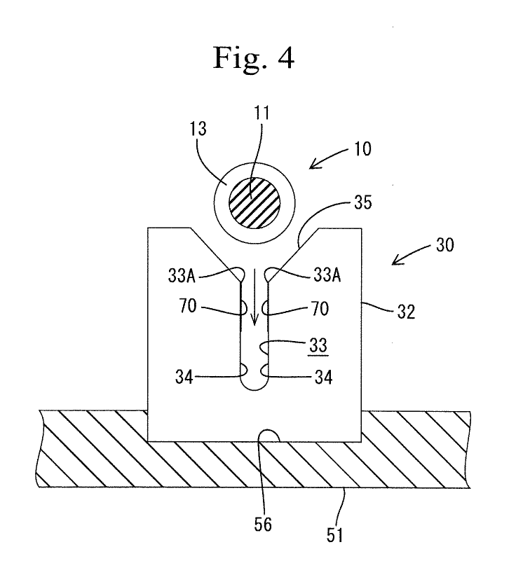

The main line uses an aluminium electric cable 10. As shown in FIG. 4, the aluminium electric cable 10 includes a core wire 11 formed by a plurality of strands made of aluminium or aluminium alloy. The core wire 11 is covered with a synthetic resin insulation sheath 13. FIGS. 4 to 6 show schematically a cross section of the core wire 11 comprising a plurality of aluminium strands, as a whole.

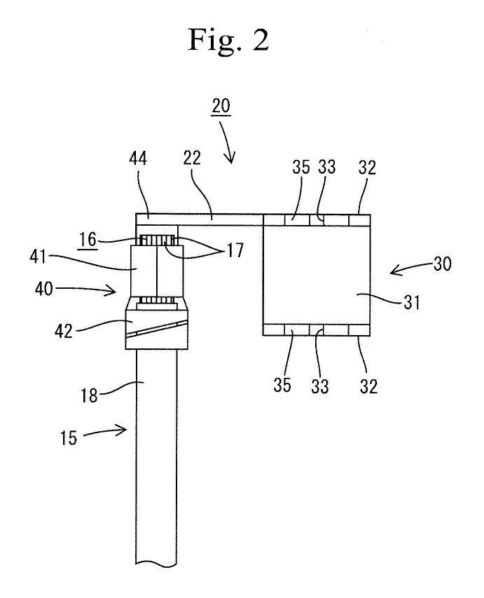

A branched line uses a copper electric cable 15. As shown in FIG. 2, the copper electric cable 15 includes a core wire 16 formed by a plurality of copper alloy strands 17. The core wire 16 is covered with a synthetic resin insulation sheath 18.

The splicing terminal assembly 20 is formed by pressing a metallic plate (for example, a copper or copper alloy plate) and is plated with tin (Sn). As shown in FIGS. 1 and 2, the insulation displacement terminal 30 and a crimp terminal 40 are laterally arranged and connected to each other.

An end of the branched copper electric cable 15 is connected to the crimp terminal 40. The crimp terminal 40 includes a wire barrel 41 and an insulation barrel 42 connected to the wire barrel 41 at a front side.

The wire barrel 41 is caulked and pressed onto an end of the core wire 16 exposed by removing an insulation sheath 18 from the copper electric cable 15. The wire barrel 41 includes a pair of wide barrel pieces 41A that stand up from right and left edges of a bottom plate 43 to be opposed to each other. Both barrel pieces 41A are confronted to each other so that the barrel pieces 41A surround an outer periphery of the end of the core wire 16 at both sides, and are caulked onto the end in a so-called heart-like shape.

The insulation barrel 42 is caulked and pressed onto an end of the remained insulation sheath 18. The insulation barrel 42 includes a pair of right and left barrel pieces 42A provided on right and left side edges of the bottom plate 43 and projected upward to be shifted from each other in a back-and-forth direction. Each barrel piece 42A is narrower and higher than each barrel piece 41A. Projecting ends of both barrel pieces 42A are overlapped on each other in the back-and-forth direction so that the both barrel pieces 42A surround an outer periphery of an end of the insulation sheath 18 in the right and left direction to be caulked onto the end.

The wire barrel 41 is provided on an inner part with a connecting section 44 that projects upright from an inner side of the bottom plate 43.

A mid position of the main line aluminium electric cable 10 in its longitudinal direction is connected to the insulation displacement terminal 30. The terminal 30 includes a base plate 31 extending in a back-and-force direction and a pair of press-contact blades 32 each projecting upright from each of front and back ends of the base plate 31. Each press-contact blade 32 is provided in a central part in its width direction with a press-contact groove 33 that is open at an upper edge. The press-contact groove 33 is provided on its upper end or its inlet port with a guide portion 35 that is tapered downward. A size in width of the press-contact groove 33 is set to be smaller than a diameter of the core wire 11 in the aluminium electric cable 10. A size in depth of the press-contact groove 33 is set to be about 1.5 times the diameter of the aluminium electric cable 10.

The crimp terminal 40 and insulation displacement terminal 30 constructed above are arranged and spaced apart from each other by a given distance in a right and left direction. An elongated connecting plate 22 is bridged between a inner part of the connecting section 44 of the crimp terminal 40 and a left side lower end of the press-contact blade 32 at the inner part in the insulation displacement terminal 30, thereby forming the splicing terminal assembly 20 in which the crimp terminal 40 and insulation displacement terminal 30 are integrated.

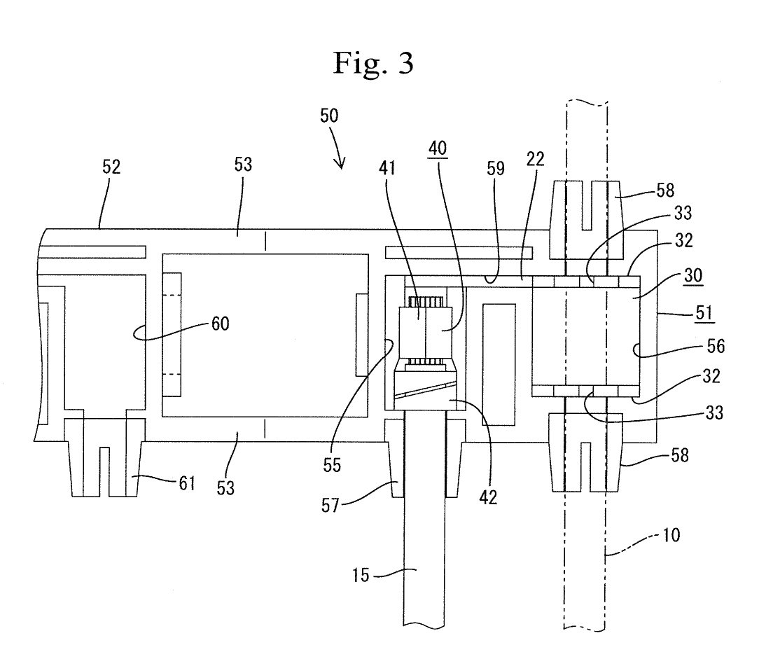

As shown in FIG. 3, a housing 50 contains the splicing terminal assembly 20 constructed above. The housing 50 is made of synthetic resin. The housing 50 includes a housing main body 51, a cover 52 mounted on an upper surface of the housing main body 51 at its side position, and a hinge 53 coupling the cover 52 to the housing main body 51.

The housing main body 51 on right and left sides with two mounting recesses 56 and 55. The left side (a side provided with the hinge 53) mounting recess 55 is adapted to receive the crimp terminal 40 caulked and crimped on the end of the copper electric cable 15. In particular, the crimp terminal 40 is positioned and fitted in the mounting recess 55 so that the terminal 40 cannot move in the back-and-forth direction. The left side mounting recess 55 is provided on its front side with a cable support section 57 that receives a lower surface of the copper electric cable 15 drawn out of the crimp terminal 40.

On the other hand, the right side mounting recess 56 receives a bottom part of the insulation displacement terminal 30. Specifically, the bottom part of the insulation displacement terminal 30 is tightly fitted in the recess 56 so that the terminal 30 cannot move in the back-and-forth direction and in the right and left direction. The right side mounting recess 56 is provided on its front side and back side with cable support sections 58 that receive a lower surface of the aluminium electric cable 10 drown out of the front and back sides of the insulation displacement terminal 30.

The housing main body 51 is provided with a mounting groove in which a lower part of the connecting plate 22 is tightly fitted to interconnect the inner parts of the right and left mounting recesses 56 and 55 to each other.

The cover 52 is attached to the upper surface of the housing 50 so that the cover 52 is turned inside out from the state shown in FIG. 3, while the hinge 53 is being bent rightward. The cover 52 is locked on a regular positioned by a locking mechanism (not shown). Although a part of the cover 52 is omitted in FIG. 3, the cover 52 is provided with a mounting recess 60 and a cable support section 61. The mounting recess 60 is fitted on an upper surface side of the crimp terminal 40 caulked on the end of the copper electric cable 15. The cable support section 61 clamps the upper surface of the copper electric cable 15 drawn out to the front side from the crimp terminal 40 between the section 61 of the cover 52 and the cable support section 57 of the housing main body 51.

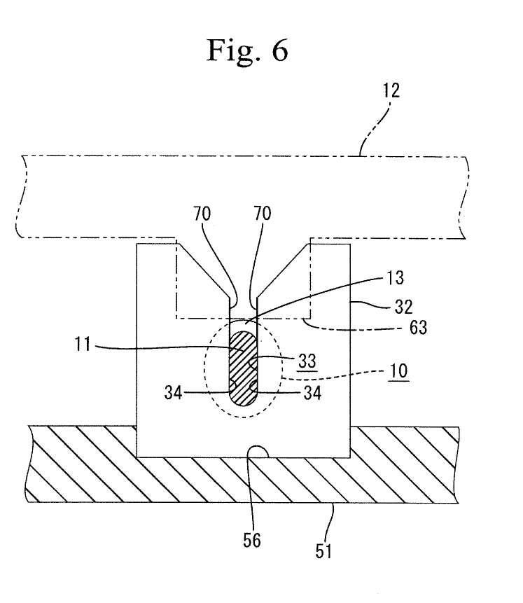

As shown in FIG. 6, the cover 52 is provided with a holding section 63 and a cable support section (not shown). The holding section 63 extends to reach the aluminium electric cable 10 inserted into a regular position (mentioned after) in the insulation displacement terminal 30 in a space between the front and back press-contact blades 32, when the cover 52 is mounted on the housing main body 51 at a regular position, as shown by chain lines in FIG. 6. The cable support section (not shown) clamps an upper surface of the aluminium electric cable 10 drawn out of the front and back sides of the insulation displacement terminals 30 between the cable support section and the cable support section 58 of the housing main body 51.

The front and back press-contact blades 32 of the insulation displacement terminal 30 that constitutes the splicing terminal assembly 20 are provided with stripping tooth section 70 (corresponding to a stripping section in the present invention) that serves to strip an oxide layer formed on a surface of the core wire 11 in the aluminium electric cable 10.

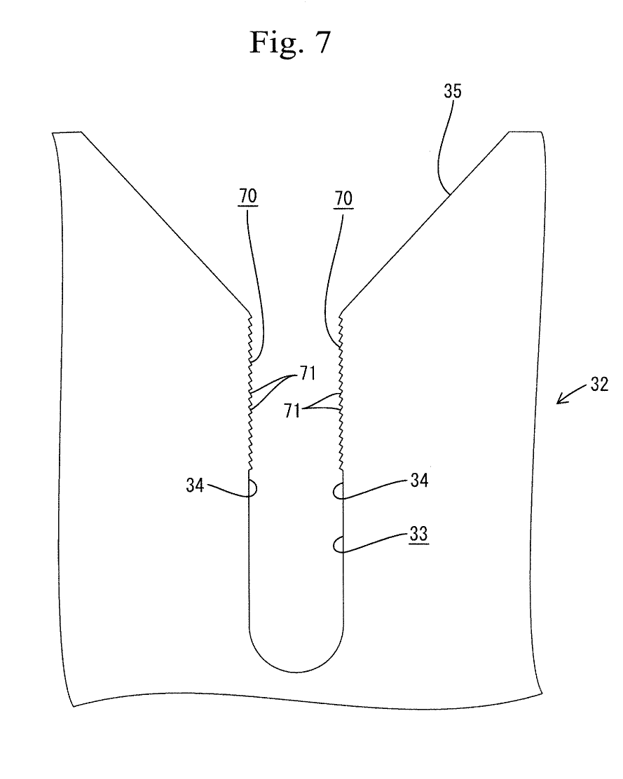

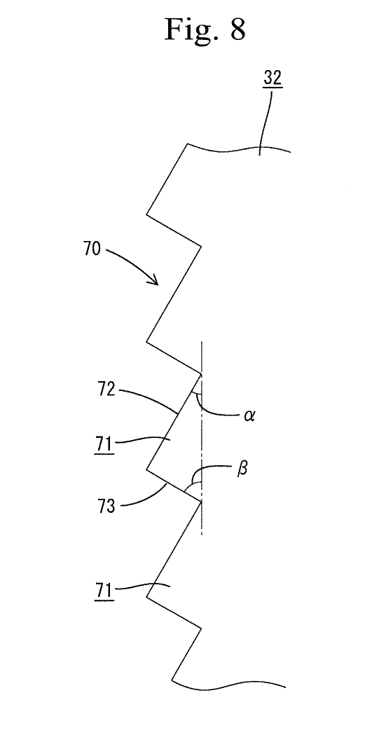

Specifically, as shown in FIG. 7, the stripping tooth section 70 is provided on its upper half part (near the guide section 35) of each of right and left groove edges 34 on the press-contact groove 33 in each press-contact blade 32. The stripping tooth section 70 includes a plurality of teeth 71 arranged in an upper and lower direction. Essentially, each tooth 71 is formed into a sharply angled crest-like shape. As shown in FIG. 8, an upper side gentle slope 72 of the tooth 71 has an slant angle α (alpha) of less than 45 degrees (for example, 30 degrees) with respect to a longitudinal direction of the press-contact groove 33 while a lower side steep slope 73 has an slant angle β (beta) of more than 45 degrees (for example, 60 degrees).

Next, an operation of the splicing terminal assembly in the first embodiment will be described below.

An example of a splicing work will be described as follow. Firstly, an end of the branched copper electric cable 15 is connected to the crimp terminal 40 of the splicing terminal assembly 20. An end of the insulation sheath 18 is stripped from the copper electric cable 15 to expose a given length of an end of the core wire 16. On the other hand, the splicing terminal assembly 20 is set on a crimp machine equipped with an anvil and a crimper. The end of the exposed core wire 16 is disposed on the wire barrel 41 of the crimp terminal 40 while an end of the remained insulation sheath 18 is disposed on the insulation barrel 42 of the terminal 40. Both barrels 41 and 42 are clamped between the anvil and the crimper to be caulked. Thus, as shown in FIG. 2, the wire barrel 41 is caulked on the end of the core wire in a hear-like shape while the insulation barrel 42 is caulked on the end of the insulation sheath 18 so as to be overlapped in the back-and-forth direction. In other words, the crimp terminal 40 of the splicing terminal assembly 20 is connected to the branched copper electric cable 15.

As described above, the splicing terminal assembly 20 connected to the end of the copper electric cable 15, as shown in FIG. 3, is mounted on the housing main body 51 of the housing 50 which is at an open position. Specifically, the bottom portion of the insulation displacement terminal 30 in the splicing terminal assembly 20 is tightly fitted into the right side mounting recess 56, the lower portion of the connecting plate 22 is fitted into the mounting groove 59, and the crimp terminal 40 caulked on the end of the copper electric cable 15 is attached to the left side mounting recess 55. The copper electric cable 15 drawn out of the crimp terminal 40 is received in the cable support section 57.

Thus, although it is not described in detail, the splicing terminal assembly 20 connected to the end of the copper electric cable 15 is set on a lower die of the insulation displacement machine. Then, as shown by chain lines in FIG. 3, a mid portion of the main line aluminium electric cable 10 in the longitudinal direction is disposed above the insulation displacement terminal 30 in the splicing terminal assembly 20. Thereafter, an upper die of the insulation displacement machine is moved down and a pushing section of the upper die pushes down the aluminium electric cable into a pace between both press-contact blades 32 and spaces outside the press-contact blades 32, as shown by an arrow in FIG. 4.

Thus, the aluminium electric cable 10 is pushed into the press-contact grooves 33 in the corresponding press-contact blades 32 of the insulation displacement terminal 30 at given two front and back side positions of the cable 10. The aluminium electric cable 10 is pushed into the press-contact grooves 33 while the cable 10 is being guided by the guide portion 35, and the insulation sheath 13 is broken by upper sharp distal ends 33A of the press-contact grooves 33. Thus, the exposed core wire 11 is pushed into the press-contact grooves 33 while the exposed core wire 11 is contacting with the groove edges 34 on the press-contact grooves 33.

In particular, in the aluminium electric cable 10, the core wire 11 comprising the aluminium strands is likely to generate an oxide layer on the surface of the core wire 11. There is a possibility of generating the oxide layer on the surface of the core wire 11 at the initial step of producing the aluminium electric cable 10. Accordingly, if the groove edges 34 of the press-contact grooves 33 are smooth, the oxide layer on the surface of the exposed core wire 11 slides down on the groove edges 34 when the core wire 11 is pushed down in the press-contact grooves 33. Consequently, there is a possibility that the oxide layer will remains on the surface of the core wire without being stripped. Then, the aluminium electric cable 10 and press-contact blades 32 may be connected to each other under a condition where the oxide layer is interposed between them, thereby increasing an electrical resistance.

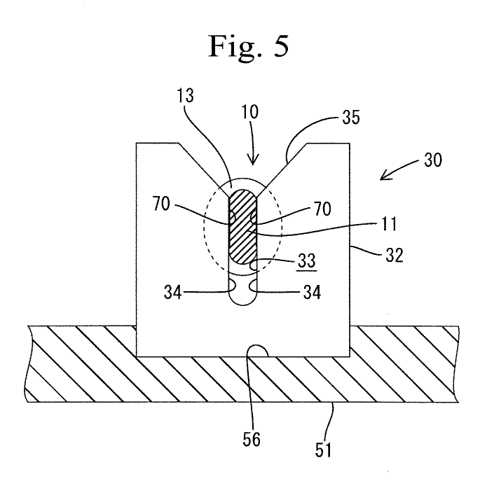

On the contrary, in the first embodiment, since the right and left groove edges 34 of the press-contact groove 33 of each press-contact blade 32 is provided on a substantially upper half part near the guide portion 35 with the stripping tooth section 70, as shown in FIG. 5, the insulation sheath 13 of the aluminium electric cable 10 is broken to expose the core wire 11, the exposed core wire 11 is pushed down into the press-contact grooves 33, and the stripping tooth section 70 contacts with the surface of the core wire 11. Specifically, the sharp distal end of each tooth 71 that constitutes the stripping tooth section 70 contacts with the surface of the core wire 11 in sequence, thereby stripping the oxide layer generated on the surface of the core wire 11.

As shown in FIG. 6, when the aluminium electric cable 10 is pushed down into the regular position in the press-contact grooves 33, an emergent surface formed on the surface of the core wire 11 by stripping the oxide layer will contact with lower side smooth areas on both groove edges 34 of each press-contact groove 33.

After a regular press-contact work for the aluminium electric cable 10 has been finished, as described above, the upper die of the press-contact machine is retracted upward, and the cover is turned inside out while bending the hinge 53 so that the cover is mounted and locked on the housing main body 51. In connection with this step, a holding portion 63 of the cover 52 moves to a position directly above the aluminium electric cable 10, and the cable 10 is held at the regular press-contact position. Then, the housing 50 incorporated with the splicing terminal assembly 20 is taken from the press-contact machine. Thus, a work of connecting the branched copper electric cable 15 to the main line aluminium electric cable 10 has been completed. In this case, the emergent surface caused by removing the oxide layer from the surface of the core wire 11 at the portion of the aluminium electric cable 10 that is brought into press-contact with the insulation displacement terminal 30 contacts with the groove edges 34 of the press-contact grooves 33 of the insulation displacement terminal 30, thereby decreasing an electrical resistance and enhancing an electrical performance.

According to the first embodiment constructed above, in the insulation displacement terminal 30 with which the aluminium electric cable 10 is press-contacted, since the stripping tooth section 70 comprising a plurality of teeth 71 having sharply angled crest-like shapes are provided on both groove edges 34 of the press-contact grooves 33 in the press-contact blades 32, the stripping tooth section 70 breaks the insulation sheath 13 while the aluminium electric cable 10 is pushed into the press-contact grooves 33 in the press-contact blades 32, the stripping tooth section 70 slides on the exposed core wire 11, so that the oxide layer generated on the surface of the core wire 11 is stripped. Consequently, the emergent surface on the core wire 11 contacts with the groove edges 34 of the press-contact grooves 33. Thus, a contacting part between the core wire 11 and the press-contact blades 32 (that is, a press-contacted portion on the aluminium electric cable 10) will lower its electrical resistance and enhance an electrical performance.

In the first embodiment, the stripping tooth section 70 are formed only a substantially half area at the inlet port in the groove edges 34 of the press-contact grooves 33. Accordingly, at the initial step of pushing the aluminium electric cable 10, the stripping tooth section 70 slide on the surface of the core wire 11 to strip the oxide layer. At the final step of pushing the cable 10, the area of the groove edges 34 having no stripping tooth section 70 slides on the surface of the core wire 11. Thus, a pushing resistance at the final pushing step is kept to be small, thereby decreasing the pushing force, as a whole. At the finished step of pushing the cable 10, since the emergent surface of the core wire 11 contacts with the area of the groove edges 34 of the press-contact grooves 33 having no stripping tooth section 70, it is possible to increase the contact area, thereby enhancing reliability in electrical connection.

The stripping tooth 70 includes the tooth 71 having the sharply angled crest-like shape. A plurality of teeth 71 are arranged in a pushing direction (in an upper and lower direction) of the aluminium electric cable 10. In each tooth 71 of the stripping tooth section 70, a front side (upstream side in the pushing direction of the cable 10) slope 72 is gentle and an inner side (downstream side) slope 73 is steep.

Accordingly, when the exposed core wire 11 in the aluminium electric cable 10 is pushed down along the press-contact grooves 33, the sharply angled crest-like distal end of each tooth 71 that constitutes the stripping tooth section 70 slides on the surface of the core wire 11 in sequence, so that the oxide layer generated on the surface of the core wire 11 is positively stripped.

When the exposed core wire 11 in the aluminium electric cable 10 is pushed down along the press-contact grooves 33, the gentle slope 72 of the sharply angled crest-like distal end of each tooth 71 slides on the surface of the core wire 11 in sequence, so that the pushing resistance is kept to be lower, and after finishing the pushing step, the core wire 11 contacts with the steep slope 73, so that the core wire 11 is hardly drawn out of the press-contact grooves 33.

### Second Embodiment

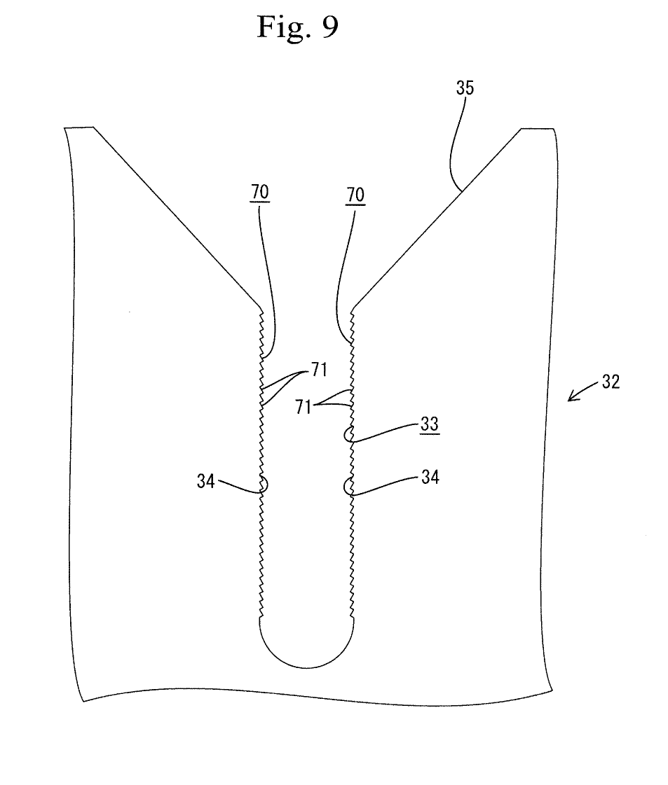

A second embodiment of the splicing terminal assembly 20 in accordance with the present invention will be described below by referring to FIG. 9.

As described in the first embodiment, the splicing terminal assembly 20 is used for the main line aluminium electric cable 10, and the copper electric cable 15 is branched from the main line aluminium electric cable 10 through the splicing terminal assembly 20. In particular, if a portion of the aluminium electric cable 10 that is press-contacted with the insulation displacement terminal in the splicing terminal assembly 20 is located under a hard condition in which cooling and heating actions are repeated at a mounting position of a wire harness, the core wire 11 of the aluminium electric cable 10 repeats contraction and expansion. In particular, when the core wire 11 is contracted, a gap is caused between the core wire 11 and the groove edges 34 of the press-contact grooves 33, thereby involving a possibility that another contact resistance may be generated.

In view of the above problem, the second embodiment further improves the splicing terminal assembly 20. As shown in FIG. 9, the right and left groove edges 34 of the press-contact grooves 33 of each press-contact blade 32 of the insulation displacement terminal 30 are provided on substantially whole lengths with the stripping tooth section 70. The stripping tooth section 70 includes a plurality of teeth 71 that have sharply angled crest-like shape with the gentle slopes 72 at the upstream side and the steep slopes 73 at the downstream side, as is the case with the first embodiment.

According to the above structure, while the exposed core wire 11 in the aluminium electric cable 10 is being pushed down along the groove edges 34 to the regular position in the press-contact grooves 33, the stripping tooth section 70 continues to slide on the surface of the core wire 11. In particular, in the upper side area of the press-contact grooves 33, the stripping tooth section 70 strips the oxide layer on the surface of the core wire 11. In the lower area including the regular pushing position, the stripping tooth section 70 rather bites the emergent surface of the core wire 11.

Accordingly, in the case where the aluminium electric cable 10 is disposed at the finished press-contact position, even if the press-contacted portions of the cable 10 are cooled and contracted, the stripping tooth section 70 bites the surface of the core wire 11, so that a contact condition between the core wire 11 and the groove edges 34 of the press-contact grooves 33 is maintained, thereby preventing the contact resistance from being generated.

### Third Embodiment

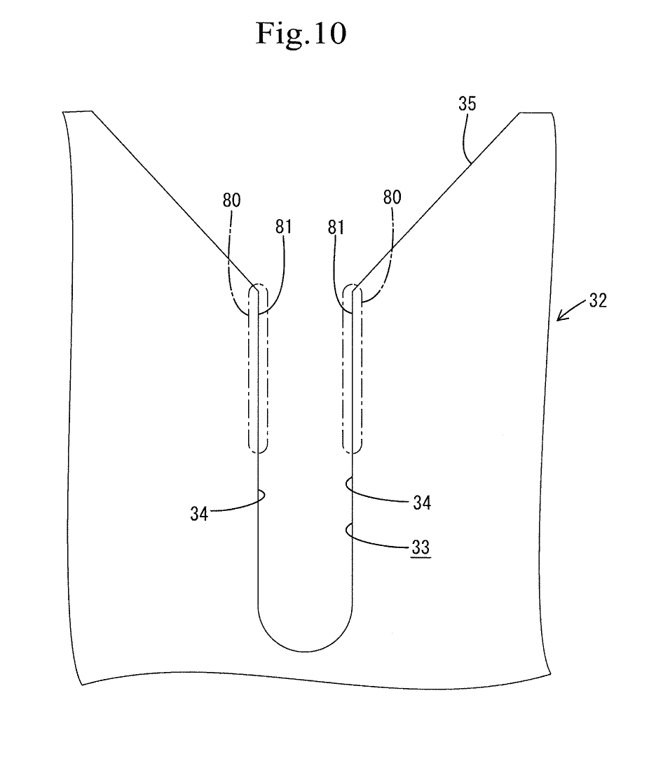

FIG. 10 shows a third embodiment of the splicing terminal assembly in accordance with the present invention. Generally, the insulation displacement terminal 30 is formed by cutting and bending a copper or copper alloy plate into a given shape by a press machine. Then, the terminal 30 is dipped in molten tin (Sn) to plate the terminal 30.

In the third embodiment, an approximately half area 80 of the right and left groove edges 34 of the press-contact grooves 33 in the press-contact blades 32 near the guide portion 35 is masked before plating. Accordingly, the groove edges 34 on the area 80 are left as originally cut surfaces. In result, stripping portions 81 are provided with relatively rough surfaces.

According to the third embodiment, when the insulation sheath 13 of the aluminium electric cable 10 is broken by the press-contact grooves 33 in the press-contact blades 32 to expose the core wire 11 and the exposed core wire 11 is pushed down into the grooves 33, firstly both side stripping portions 81 slide on the surface of the core wire 11. Specifically, when the rough surfaces of the stripping portions 81 slide on the surface of the core wire 11 in sequence, the oxide layer generated on the surface of the core wire 11 is stripped.

Secondly, when the aluminium electric cable 10 is pushed down into the regular position in the press-contact grooves 33, the emergent surface formed by stripping the oxide layer on the surface of the core wire 11 is pushed onto and contacted with the lower side Sn-plated area on both groove edges 34 of the press-contact grooves 33. At this time, aluminium Al on the emergent surface and plating tin (Sn) are alloyed and the core wire 11 and groove edges 34 in the press-contact grooves 33 are brought into contact with each other. Consequently, the contacting portion between the core wire 11 and the press-contact blades 32 (that is, press-contacted portion of the aluminium electric cable 10) will lower the electrical resistance, thereby enhancing an electrical performance.

### The Other Embodiments

It should be noted that the present invention is not limited to the above embodiments described above and illustrated in the drawings. For example the following embodiments will fall within a technical scope of the present invention.

(1) Although the stripping tooth section or the stripping section comprising the original rough cut surfaces is provided on both groove edges of the press-contact groove in the above embodiments, the stripping tooth section or the stripping section may be provided on only either of the groove edges.

(2) The crest-like shape of each tooth that constitutes the stripping section may be any type shape such as upper and lower sides slopes having the same slant angle, and upper side slant surface and lower side horizontal surface.

(3) The stripping tooth section may be provided with a plurality of teeth that are juxtaposed and spaced apart from one another by a given distance.

(4) The insulation displacement terminal may be provided with two front and rear press-contact blades that are shifted in a right and left direction. The insulation displacement terminal may include a single press-contact blade or more than three press-contact blades.

(5) The insulation displacement terminal may be provided instead of a crimp section (barrel) of a male terminal or a female terminal to be connected to an end of a covered electric cable at a rear side from a connecting section to be connected to a mating terminal.

(6) The splicing terminal assembly may be provided with two insulation displacement terminals juxtaposed laterally and connected to each other.

(7) The present invention can be applied to a joint terminal in which a plurality of insulation displacement terminals are juxtaposed laterally and connected to one another.

(8) Although the aluminium electric cable is exemplified as the covered electric cable to be connected to the insulation displacement terminal in the above embodiments, the other electric cables such as a copper electric cable may be utilized.

(9) The original cut rough surfaces of the groove edges that are not plated in the third embodiment may be formed on inner longitudinal areas in the groove edges of the press-contact grooves.

1. An insulation displacement terminal comprising:
a press-contact blade, said press-contact blade including a press-contact groove into which a covered electric cable covered with an insulation sheath around a conductive core wire can be pushed, when said covered electric cable is pushed into said press-contact groove, said insulation sheath being broken to expose said core wire, so that said exposed core wire is brought into press-contact with groove edges of said press-contact groove and is electrically coupled to said groove edges; and
a stripping section provided on at least one of said groove edges of said press-contact groove in said press-contact blade, said stripping section being adapted to slide on a surface of said exposed core wire.

2. An insulation displacement terminal according to claim 1, wherein when said insulation sheath is broken and then said stripping section slides on said surface of said exposed core wire, said stripping section strips a layer generated on said surface of said core wire, and an emergent surface on said core wire is brought into contact with said groove edges of said press-contact groove.

3. An insulation displacement terminal according to claim 1, wherein said stripping section is provided on only longitudinal areas on said groove edges of said press-contact groove at an upstream side in a pushing direction of said covered electric cable.

4. An insulation displacement terminal according to claim 1, wherein said stripping section is provided on longitudinal areas on said groove edges of said press-contact groove at an upstream side in a pushing direction of said covered electric cable and on inner longitudinal areas on said groove edges of said press-contact groove at a position corresponding to a finished pushing position of said covered electric cable.

5. An insulation displacement terminal according to claim 1, wherein said stripping section is a stripping tooth section in which a plurality of teeth having sharply angled crest-like shape are juxtaposed in said pushing direction of said covered electric cable.

6. An insulation displacement terminal according to claim 5, wherein each tooth that constitutes said stripping tooth section is formed into a crest-like shape having a gentle slope at an upstream side in said pushing direction of said covered electric cable and a steep slope at a downstream side in said pushing direction.

7. An insulation displacement terminal according to claim 1, wherein said stripping section is provided with an originally cut surface to which a surface treatment of plating is not applied.

8. A splicing terminal assembly wherein a crimp terminal to be connected by crimping on an end of another covered electric cable in which an insulation sheath covers an electrically conductive core wire is connected to said insulation displacement terminal according to claim 1.

9. A press-contact structure for an electric cable wherein a covered electric cable in which an insulation sheath covers an electrically conductive core wire is press-connected to said insulation displacement terminal according to claim 1.

10. A press-contact structure for an electric cable wherein a covered electric cable in which an insulation sheath covers an electrically conductive core wire is press-connected to said insulation displacement terminal in said splicing terminal assembly according to claim 8.

11. A press-contact structure for an electric cable according to claim 9, wherein said covered electric cable is an aluminium electric cable in which an insulation sheath covers a core wire comprising a plurality of aluminium or aluminium alloy strands.
